(19) United States
(12) Patent Application Publication
(10) Pub. No.: US 2016/0023284 A1
(43) Pub. Date: Jan. 28, 2016

(54) CERAMIC END MILLS WITH COOLANT HOLES

(71) Applicant: Kennametal Inc., Latrobe, PA (US)

(72) Inventors: Jason GOLDSMITH, Greensburg, PA (US); Danny Ray DAVIS, Asheboro, NC (US)

(21) Appl. No.: 14/341,297

(22) Filed: Jul. 25, 2014

(51) Int. Cl. B23C 5/10

(52) U.S. Cl. CPC B23C 5/10; B23C 2210/40; B23C 2210/03; B23C 2226/18; B23C 2250/12

(57) ABSTRACT

In one aspect, end mills are described herein, at least a portion of which comprise or formed of ceramic material. An end mill described herein comprises a shank portion extending along a longitudinal axis of the end mill, a cutting portion extending from the shank portion, the cutting portion formed of a ceramic material and comprising a plurality of blades disposed at a helical angle from the longitudinal axis along an axial length of cut and extending onto a cutting end surface of the end mill, and at least one fluid transport hole extending along the longitudinal axis and terminating in the cutting end surface.

### FIELD

The present invention relates to end mills and, in particular, to ceramic end mills employing one or more fluid transport holes.

### BACKGROUND

End mills of various design and construction are well known and advantageously employed in a number of cutting applications. Over time, cutting speeds achieved by end mills have increased to provide greater efficiencies in cutting and machining operations. In order to accommodate increased cutting speeds, new geometries and materials have been introduced.

To combat breakage and other degradative pathways, end mills are conventionally fabricated from impact resistant materials including high speed steels and cermets, such as cemented tungsten carbide. To the extent that ceramic materials have been used, due to their brittleness, they are largely restricted to cutting edge inserts removably fixed to a body made of a more impact resistant material. Rarely is a machining tool, such as an end mill, that may be subjected to side loading made monolithically with at least a cutting portion formed of ceramic material. End mill design continues to evolve in response to the changing demands of cutting applications, thereby calling for the development of new end mill materials and associated architectures.

### SUMMARY

In one aspect, end mills are described herein comprising a cutting portion formed of a ceramic material and at least one fluid transport hole along the longitudinal axis of the end mill. For example, an end mill described herein comprises a shank portion extending along a longitudinal axis of the end mill and a cutting portion extending from the shank portion, the cutting portion formed of a ceramic material and comprising a plurality of blades disposed at a helical angle from the longitudinal axis along an axial length of cut and extending onto a cutting end surface of the end mill. At least one fluid transport hole extends along the longitudinal axis, terminating in the cutting end surface.

In another aspect, methods of making an end mill are described herein. A method of making an end mill comprises providing a ceramic powder composition, pressing the powder composition into a green blank having a longitudinal axis and mechanically working the green blank to provide at least one fluid transport hole extending along the longitudinal axis and terminating in a cutting end surface of the end mill. The blank is also mechanically worked to provide a cutting portion comprising a plurality of blades disposed at a helical angle from the longitudinal axis along an axial length of cut and extending onto the cutting end surface. In some embodiments, the green blank is presintered prior to mechanically working the blank to provide the cutting portion.

In a further aspect, methods of machining an object are described herein. A method of machining an object comprises contacting the object with an end mill rotating about a longitudinal axis at a predetermined cutting speed, the end mill comprising a shank portion and a cutting portion extending from the shank portion, wherein the cutting portion is formed of a ceramic material and comprises a plurality of blades disposed at a helical angle from the longitudinal axis along an axial length of cut and extending onto a cutting end surface of the end mill. At least one fluid transport hole extends along the longitudinal axis of the end mill terminating in the cutting end surface. In some embodiments, a fluid is flowed through the at least one fluid transport hole, the fluid exiting at the cutting end surface. The fluid can cool the ceramic cutting portion of the end mill and assist in the evacuation of chips during machining of the object.

These and other embodiments are described in greater detail in the detailed description which follows.

### BRIEF DESCRIPTION OF THE DRAWINGS

FIG. 1 illustrates a plan view of a solid end mill according to one embodiment described herein.

FIG. 2 illustrates an end view of the solid end mill of FIG. 1.

### DETAILED DESCRIPTION

Embodiments described herein can be understood more readily by reference to the following detailed description and examples and their previous and following descriptions. Elements and apparatus described herein, however, are not limited to the specific embodiments presented in the detailed description. It should be recognized that these embodiments are merely illustrative of the principles of the present invention. Numerous modifications and adaptations will be readily apparent to those of skill in the art without departing from the spirit and scope of the invention.

### I. End Mills

An end mill described herein comprises a shank portion extending along a longitudinal axis of the end mill and a cutting portion extending from the shank portion, the cutting portion formed of a ceramic material and comprising a plurality of blades disposed at a helical angle from the longitudinal axis along an axial length of cut and extending onto a cutting end surface of the end mill. At least one fluid transport hole extends along the longitudinal axis, terminating in the cutting end surface. In some embodiments, fluid transport hole(s) are collinear with the longitudinal axis of the end mill. For example, an end mill described herein can comprise a single fluid transport hole collinear with the longitudinal axis of the end mill and terminating in a central region of the cutting end surface. Alternatively, fluid transport hole(s) can helically extend along the longitudinal axis of the end mill.

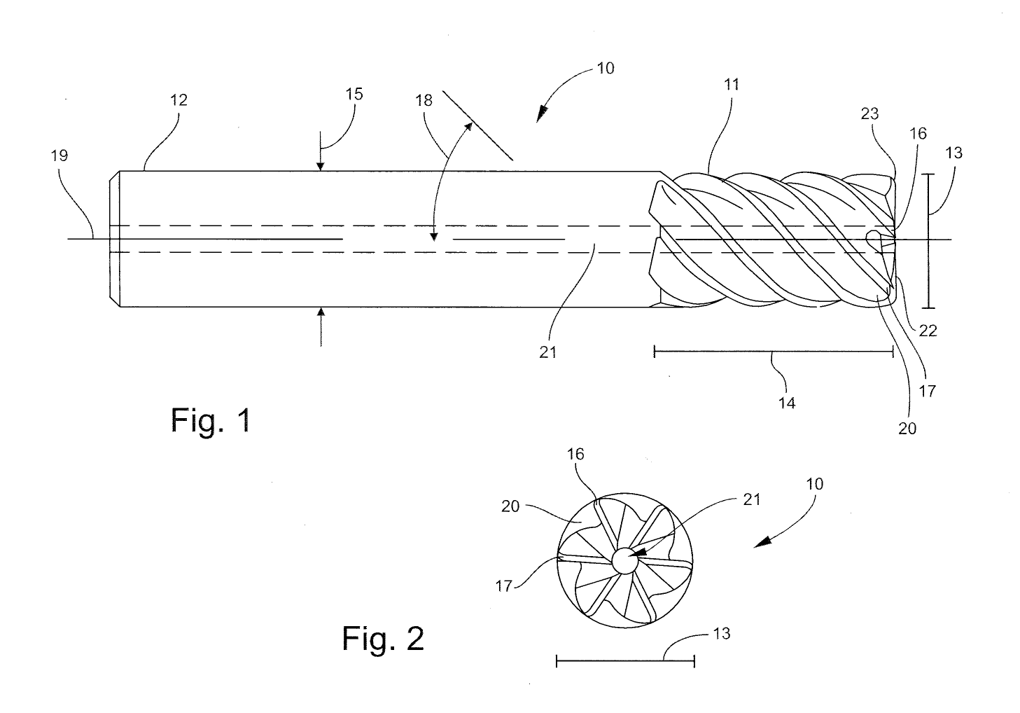

A fluid transport hole of an end mill described herein can have any diameter not inconsistent with the objectives of the present invention. Fluid transport hole diameter can be selected according to several considerations including desired flow rate capacity, fluid identity and structural integrity of the end mill. As described further herein, fluid transport hole(s) can pass a variety of fluids, including gases such as cooled air and liquids such as water and oils. In some embodiments, fluid transport hole diameter is 0.05 to 0.25 times the cutting diameter of the end mill. As illustrated in FIG. 1, the cutting diameter of the end mill is defined by the cutting end surface. Fluid transport hole diameter can also be 0.08 to 0.13 times the cutting diameter or 0.1 to 0.125 times the cutting diameter of the end mill.

The cutting portion of the end mill is formed of a ceramic material and comprises a plurality of blades disposed at a helical angle from the longitudinal axis along an axial length of cut. The blades also extend onto a cutting end surface of the end mill. The blades can be arranged at any helical angle not inconsistent with the objectives of the present invention. Further, the blades are separated from one another by flutes. An end mill described herein can have any desired number of blades and flutes. In some embodiments, the end mill has a number of flutes selected from Table I.

TABLE I
End mill number of flutes
≧4
≧6
≧8
4-12
4-10

The cutting portion of the end mill can be formed of any ceramic material not inconsistent with the objectives of the present invention. In some embodiments, the ceramic material comprises a silicon nitride, silicon aluminum oxynitride (SiAlON) or mixtures thereof. SiAlON, for example, can comprise between about 2 and about 20 wt. % aluminum, between about 1 and about 12 wt. % oxygen, between about 2 and about 12 wt. % total of one or more rare earth elements and a balance of silicon and nitrogen. In some embodiments, SiAlON comprises up to 80 wt. % alpha phase at a surface of the cutting portion. A surface of the cutting portion is considered to extend into the body of the cutting portion a distance of 20 μm. Moreover, bulk SiAlON of the cutting portion can exhibit up to 50 wt. % alpha phase. Table II provides several examples of SiAlON compositions that may be employed in formation of the ceramic cutting portion of the end mill.

TABLE II
SiAlON Compositions

| | | Bulk |
|---|---|---|
| | | alpha- |
| | | phase |
| SiAlON | Compositional Parameters (wt. %) | (wt. %) |
| 1 | Si,N—(3-7)%Al—(1-4)%O—(3-8)%Yb—(0-1)%La | 10-50 |
| 2 | Si,N—(5-7)%Al—(3-4)%O—(6-8)%Yb | 20-45 |
| 3 | Si,N—(6-7)%Al—(3-4)%O—(5-6)%Yb—(0.1-1)%La | 20-35 |
| 4 | Si,N—(3-5)%Al—(1-2)%O—(3-5)Yb—(0.1-1)%La | 25-45 |

Several SiAlON compositions are commercially available from Kennametal Inc. of Latrobe, Pa. under the KY1540™, KYS30™ and SP1300™ trade designations. Additional ceramic materials for the cutting portion can include silicon carbide (SiC), SiC whisker containing alumina(s) or mixtures thereof.

As described herein, the end mill also comprises a shank portion from which the cutting portion extends. In some embodiments, the shank portion is made of a ceramic material. The ceramic material can be the same or different than the ceramic of the cutting portion. When the ceramic material of the shank and cutting portions are the same or substantially the same, the end mill can have a continuous monolithic construction. Alternatively, the shank can be formed of steel or sintered cemented carbide. In such embodiments, the monolithic ceramic cutting portion can be coupled to the shank portion by brazing or other coupling technique. End mills including ceramic constructions and designs described herein can be solid end mills. Alternatively, the end mills can be indexable wherein the cutting insert support of the cutting portion is formed of a ceramic material and the associated cutting inserts are also formed of a ceramic material.

Referring now to FIGS. 1 and 2, there is illustrated a solid end mill, generally designated as reference number 10, in accordance with one embodiment described herein. As provided in FIGS. 1 and 2, end mill (10) has a shank portion (12) extending along a longitudinal axis (19) of the end mill (10). The cutting portion (11) extends from the shank portion (12) and comprises a plurality of blades (16, 17) disposed at a helical angle (18) from the longitudinal axis (19) along an axial length of cut (14) and extending onto a cutting end surface (22) of the end mill (10). The blades (16, 17) can have radiused corners (23) at their transitions onto the cutting end surface (22). The blades (16, 17) are separated by flutes (20). In some embodiments, the end mill (10) can have at least 4 flutes (20). In some embodiments, as in FIGS. 1 and 2, the end mill (10) can have at least 6 flutes (20). The cutting end surface (22) defines a cutting diameter (13). Although the shank diameter (15) in the embodiments of FIGS. 1 and 2 is substantially the same as the cutting diameter (13), these diameters may be substantially different. The end mill (10) comprises at least one fluid transport hole (21) extending along the longitudinal axis (19) and terminating in the cutting end surface (22). As illustrated in FIG. 1, the fluid transport hole (21) is collinear with the longitudinal axis (19) runs the entire length of the end mill (10) from the cutting end surface (22) through the end surface of the shank portion (12).

FIG. 2 illustrates an end view of the end mill (10) of FIG. 1. FIG. 2 shows the separations of adjacent blades (16, 17) by flutes (20). FIG. 2 further illustrates the fluid transport hole (21) extending along the longitudinal axis (19) and terminating in the cutting end surface (22). Although the at least one fluid transport hole (21) of FIGS. 1 and 2 is illustrated by a single fluid transport hole (21) collinear with the longitudinal axis (19), other configurations are also contemplated as described herein.

### II. Methods of Making End Mills

In another aspect, methods of making end mills are described herein. A method of making an end mill comprises providing a ceramic powder composition, pressing the ceramic powder composition into a green blank having a longitudinal axis and mechanically working the green blank to provide at least one fluid transport hole extending along the longitudinal axis and terminating in a cutting end surface of the end mill. The blank is further worked to provide a cutting portion comprising a plurality of blades disposed at a helical angle from the longitudinal axis along an axial length of cut and extending onto the cutting end surface.

Referring now to specific steps or components, methods of making end mills described herein comprise providing a ceramic powder composition. Any ceramic powder composition can be used that is not inconsistent with the objectives of the present invention. For example, any ceramic powder composition described in Section I herein can be employed. Further, pressing the ceramic powder composition into a green blank can comprise any pressing technique and/or equipment not inconsistent with the present invention. For example, pressing the ceramic powder composition can include utilization of a single ended or a double ended press.

The green blank is mechanically worked to provide at least one fluid transport hole extending along the longitudinal axis and terminating in a cutting end surface of the end mill. For example, fluid transport hole(s) can be formed by one or more drilling operations. The fluid transport hole(s) can have dimensions, shape and/or configuration consistent with the foregoing discussion of fluid transport holes in Section I herein.

The green blank is also mechanically worked to provide a cutting portion comprising a plurality of blades disposed at a helical angle from the longitudinal axis along an axial length of cut and extending onto the cutting end surface. Mechanically working the green blank to provide a cutting portion can be performed by any technique or equipment not inconsistent with the objectives of the present invention. The cutting portion can have any design and/or properties described in Section I herein. The mechanically worked blank is subsequently sintered for densification. In some embodiments, hot isostatic pressing (HIP) can be employed in addition to the sintering process to achieve further densification of the end mill. Specific sintering and/or HIP conditions will be dependent on the compositional identity of powder ceramic materials employed.

### III. Methods of Machining an Object

In another aspect, methods of machining an object are described herein. Methods of machining an object comprise contacting the object with an end mill rotating about a longitudinal axis at a predetermined cutting speed, the end mill comprising a shank portion and a cutting portion extending from the shank portion. The cutting portion is formed of a ceramic material and comprises a plurality of blades disposed at a helical angle from the longitudinal axis along an axial length of cut and extending onto a cutting end surface of the end mill. At least one fluid transport hole extends along the longitudinal axis, terminating in the cutting end surface. The end mill can have any construction, properties and/or architecture described in Section I herein.

Moreover, a fluid can be flowed through the at least one fluid transport hole, the fluid exiting at the cutting end surface. The fluid can cool the ceramic cutting portion of the end mill and assist in the evacuation of chips during machining of the object. By assisting with chip evacuation, the fluid can reduce or preclude chip re-cutting and inhibit chip adhesion to surfaces of the end mill. Further, in some embodiments, the fluid can assist in lubricating the end mill to prevent radial edges of the end mill from sticking or jamming on a surface of the object being machined.

For the purposes of the present disclosure, a “fluid” can refer to one or more of a liquid, gas, emulsion, and/or liquid aerosol. Any fluid not inconsistent with the objectives of the present invention can be used. In some embodiments, the fluid is selected from the group consisting of water, lubrication oil(s) and air. Additionally, the fluid can be a minimum quantity lubricant (MQL). An MQL can comprise any conventional lubricant used in minimal quantities to achieve a desired result, e.g., facilitating chip evacuation and/or lubrication, without flooding the machining operation. Examples of fluids that can be used as MQLs include, but are not limited to, water, oil-based lubricants, air and/or mixtures thereof. In some cases, a quantity of MQL can be determined and/or utilized to provide chip evacuation without the introduction of thermal shock to the end mills. For example, in some embodiments, a quantity of MQL is flowed through the at least one fluid transport hole that permits even distribution of the fluid along the cutting portion, thereby preventing uneven chip evacuation throughout a cutting or machining operation.

The end mill can rotate about the longitudinal axis at any desired cutting speed. Cutting speed of the end mill can be governed by several factors including end mill size and compositional identity of the object being machined. Differing metal and alloy compositions, for example, require different cutting speeds. Generally, the cutting speed of the end mill can be selected from Table III.

TABLE III
End Mill Cutting Speed (m/min)
100-1200
100-600
600-1200

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. An end mill comprising:
a shank portion extending along a longitudinal axis of the end mill;
a cutting portion extending from the shank portion, the cutting portion formed of a ceramic material and comprising a plurality of blades disposed at a helical angle from the longitudinal axis along an axial length of cut and extending onto a cutting end surface of the end mill; and
at least one fluid transport hole extending along the longitudinal axis and terminating in the cutting end surface.

2. The end mill of claim 1, wherein the cutting end surface defines a cutting diameter, and the at least one fluid transport hole has a diameter of 0.05 to 0.25 times the cutting diameter.

3. The end mill of claim 2, wherein the at least one fluid transport hole has a diameter of 0.1 to 0.125 times the cutting diameter.

4. The end mill of claim 1, wherein the at least one fluid transport hole is a single fluid transport hole collinear with the longitudinal axis of the end mill.

5. The end mill of claim 4, wherein the single fluid transport hole terminates in a central region of the cutting end surface.

6. The end mill of claim 1, wherein the at least one fluid transport hole is a plurality of fluid transport holes helically extending along the longitudinal axis.

7. The end mill of claim 1, wherein the blades are separated from one another by flutes.

8. The end mill of claim 7 having at least 4 flutes.

9. The end mill of claim 7 having 4 to 10 flutes.

10. The end mill of claim 1, wherein the ceramic material of the cutting portion comprises silicon nitride, silicon aluminum oxynitride (SiAlON) or mixtures thereof.

11. The end mill of claim 10, wherein the ceramic material of the cutting portion is SiAlON.

12. The end mill of claim 11, wherein the SiAlON is 2 to 20 wt. % aluminum, 1 to 12 wt. % oxygen, 2 to 12 wt. % one or more rare earth elements and a balance of silicon and nitrogen.

13. The end mill of claim 11, wherein the SiAlON comprises up to 80 wt. % alpha phase at a surface of the cutting portion.

14. The end mill of claim 1, wherein the ceramic material of the cutting portion comprises silicon carbide (SiC), SiC whisker containing alumina or mixtures thereof.

15. The end mill of claim 1, wherein the shank portion is formed the ceramic material of the cutting portion.

16. The end mill of claim 1, wherein the shank portion is formed of steel or sintered cemented carbide.

17. A method of making an end mill comprising:
providing a ceramic powder composition;
pressing the ceramic powder composition into a green blank having a longitudinal axis;
mechanically working the green blank to provide at least one fluid transport hole extending along the longitudinal axis and terminating in a cutting end surface of the end mill; and
mechanically working the blank to provide a cutting portion comprising a plurality of blades disposed at a helical angle from the longitudinal axis along an axial length of cut and extending onto the cutting end surface.

18. The method of claim 17, wherein the green blank is presintered prior to mechanically working the blank to provide the cutting portion.

19. The method of claim 17, wherein the at least one fluid transport hole is a single fluid transport hole collinear with the longitudinal axis of the end mill.

20. The method of claim 17, wherein the blades are separated from one another by flutes.

21. The method of claim 20, wherein the end mill includes at least 4 flutes.

22. The method of claim 17, wherein the blank further comprises a shank portion.

23. The method of claim 17 further comprising brazing the ceramic cutting portion to a steel cutting portion of the end mill.

24. A method of machining an object comprising:
contacting the object with an end mill rotating about a longitudinal axis at a predetermined cutting speed, the end mill comprising a shank portion and a cutting portion extending from the shank portion, wherein the cutting portion is formed of a ceramic material and comprises a plurality of blades disposed at a helical angle from the longitudinal axis along an axial length of cut and extending onto a cutting end surface of the end mill and at least one fluid transport hole extends along the longitudinal axis terminating in the cutting end surface.

25. The method of claim 24 further comprising flowing fluid through the at least one fluid transport hole, the fluid exiting at the cutting end surface.

26. The method of claim 25, wherein the fluid assists in evacuation of chips during machining of the object.

27. The method of claim 25, wherein the fluid is a minimum quantity lubricant.

28. The method of claim 24, wherein the cutting speed is in excess of 100 meters per minute.

29. The method of claim 24, wherein the cutting end surface defined a cutting diameter, and the at least one fluid transport hole has a diameter of 0.05 to 0.25 times the cutting diameter.

30. The method of claim 24, wherein the at least one fluid transport hole is a single fluid transport hole collinear with the longitudinal axis of the end mill.

31. The method of claim 24, wherein the at least one fluid transport hole is a plurality of fluid transport holes helically extending along the longitudinal axis.

32. The method of claim 24, wherein the ceramic material of the cutting portion comprises silicon nitride, silicon aluminum oxynitride (SiAlON), silicon carbide (SiC), SiC whisker containing alumina, or mixtures thereof.

33. The method of claim 32, the ceramic material of the cutting end is SiAlON.

34. The end mill of claim 35, wherein the SiAlON is 2 to 20 wt. % aluminum, 1 to 12 wt. % oxygen, 2 to 12 wt. % one or more rare earth elements and a balance of silicon and nitrogen.
